(19) United States
(12) Patent Application Publication
(10) Pub. No.: US 2022/0263936 A1
(43) Pub. Date: Aug. 18, 2022

(54) MOBILE DEVICE CASE EXTENDING DEVICE THROUGH NEW FUNCTIONALITIES

(71) Applicant: Krzysztof ZIELI?SKI, Opatów (PL)

(72) Inventor: Krzysztof ZIELI?SKI, Opatów (PL)

(21) Appl. No.: 17/627,355

(22) PCT Filed: Jul. 16, 2020
(86) PCT No.: PCT/PL2020/000061

§ 371 Date: Jan. 14, 2022

(30) Foreign Application Priority Data
Jul. 17, 2019 (PL) P.430642

(51) Int. Cl. H04M 1/72409; G06F 1/16

(52) U.S. Cl. CPC H04M 1/72409; G06F 1/1656

(57) ABSTRACT

This invention relates to an extension frame for mobile devices (1) such as phones, tablets, laptops or other similar devices, consisting of removable multi-purpose modules (2), (3), (4), (5), (6), (7), (10) and (11) with socket-(8) and plug-type (9) connections, in which two screens are housed in on opposite sites: a touch display (12) and a photovoltaic display (13), which are designed to obtain solar energy to charge the device batteries.

This invention relates to an extension frame for mobile devices consisting of connecting modules, to be built in a rim manner inside the frame, of touch screens for phones, tablets, laptops and other similar screens, including TV screens and the latest generation of translucent and transparent screens such as solid planes or flexible films that are controlled, managed and communicated—as a complete whole—through touch, voice, vision and thought.

The state of the art for this invention comprises the following technical solution from the patent description US2005213762: a modular cryptographic device and a connection method as well as the following technical solutions from the patent description US2019037061: a modular device and a connection method as well as a number of other solutions which form part of the state of the art, none of which relates to the present solution.

The first solution relates to an attachable communication module and the second one to a module for additional accessories to the complete set; neither of them achieves the object of the invention, either as an embodiment of this invention or other follow-up and classified methods x, y, and z

The essence of the invention is that a frame of any extensions, configured by the manufacturer or the user himself, consists of target modules for different destination, a PCB motherboard, a SUB board, processors, internal storage, antennas, batteries, GPS, cameras, audio, vibrations, buttons, input and output connectors and other classified x, y and z, which—once combined into a closed rim on any screen such as a display and a touch panel or other classified x, y and z —make up a frame that comprises them and forms—together with that screen or screens—a complete mobile device that can, at any time, be reconstructed and extended to include other new and unknown modules and screens to configure the same and replace damaged modules and screens.

In other words, the frame configured using the modules connects and communicates with one or two screens placed on opposite ends within the frame, giving users unlimited opportunities to build new mobile devices or replace both a single module and a screen independently and with new modules and screens that will be developed in the near future according to the inventions of the same inventor.

Preferably, the frame consists of four corner modules, each equipped with two sockets, and of short and long connecting modules with two plugs for connection and transmission, as well as of circumference solidifications around its finite circumference, and each of these solidified modules is designed to contain a mounting recess for two solidified screens or any other devices in order to configure—with or inside the frame—displays and touch screens or transparent displays, or screens and photovoltaic panels and other classified x, y and z

Preferably, the frame may additionally consist of short modules with three plugs or with two plugs and a socket, or with a plug pressed into the housing and with all items of this kind in its finite connection.

Preferably, the frame may additionally consist of long modules with two plugs and a socket on the outside of the frame.

Preferably, the frame solidified and configured as stated above consists of and comprises within a typical phone with an additional screen panel consisting of photovoltaic cells to charge the phone battery.

The subject of the invention is shown in the following drawing in which

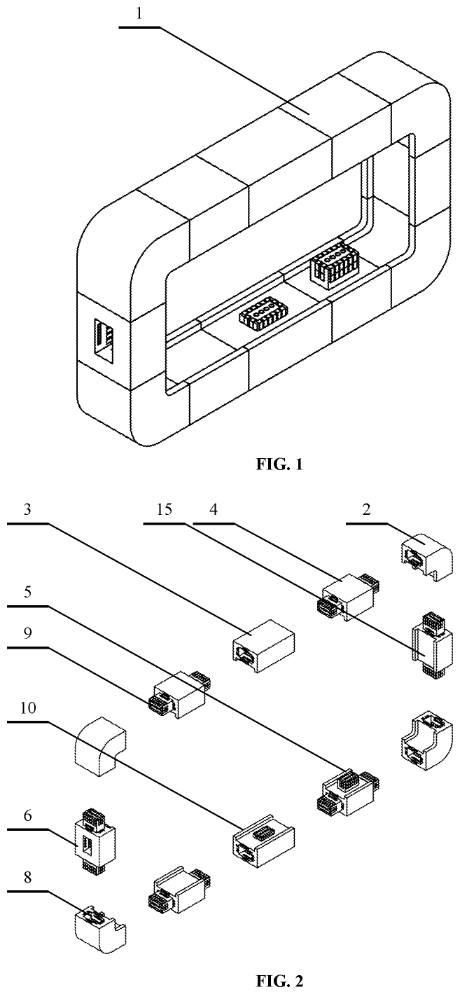

FIG. 1 shows a frame consisting of all possible short modules,

FIG. 2—a disassembled frame consisting of short modules with visible sockets and plugs, and

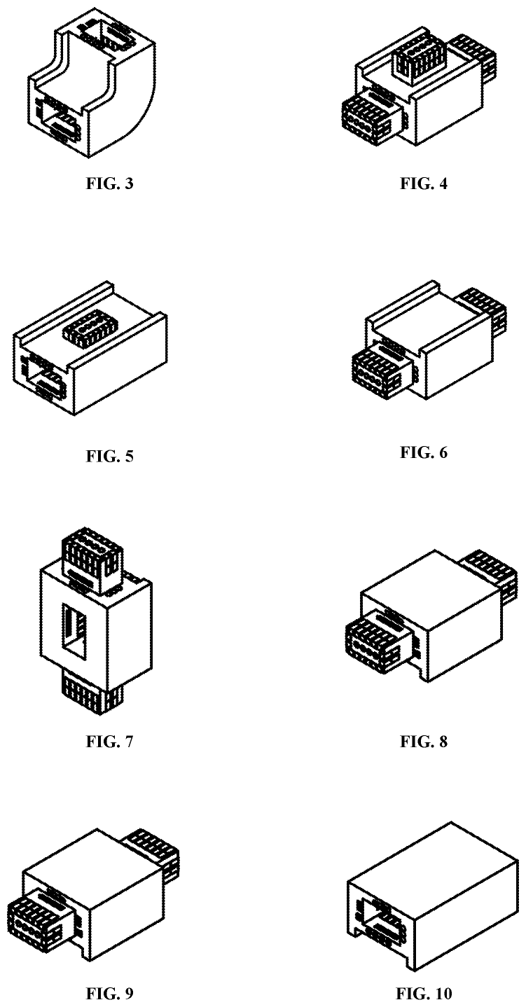

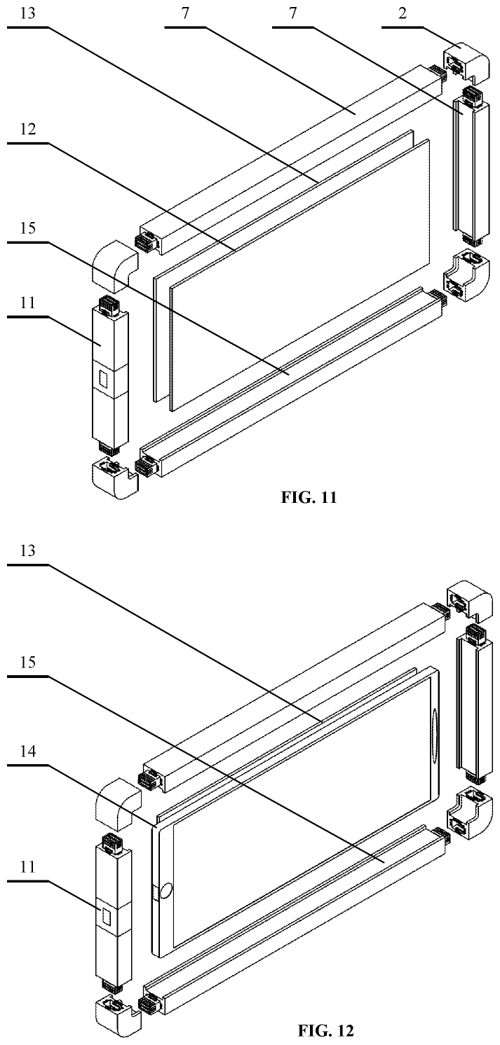

FIGS. 3, 4, 5, 6, 7, 8, 9 and 10—a detailed illustration of short modules, and

FIG. 11—a frame consisting of long modules with two pre-assembled screens, and

FIG. 12—a frame consisting of long modules with a screen and a typical phone before assembly and before connecting the sockets with plugs.

The beneficial effects of the done invention are the following: the option to build mobile phones, tablets, laptops and other mobile devices using standardised parts and to any configuration, both for the market and to individual client specifications, and to further expand or replace the damaged or unreliable modules as removable parts.

The invention can be widely used in the electronics industry and to meet basic human needs. It marks a new and promising manufacturing trend in this sector, providing users with unlimited opportunities to further develop both the new methods and the devices themselves.

1. The extension frame for mobile devices characterised in that it consists of multi-purpose modules for various uses comprising within: PCB motherboards, SUB boards, processors, internal storage, antennas, batteries, GPS, cameras, audio, vibrations, buttons, input and output connectors, and other classified (x), (y) and (z), which—once combined into a closed ground ring on any screen (12) and (13) in the form of a display and a touch panel or other classified (x), (y) and (z)—make up a frame (1) that comprises them and forms—together with these screens (12) and (13)—a complete mobile device that can, at any time, be reconstructed and extended to meet current needs and include new applications (x), (y) and (z).

2. The frame according to claim 1, characterised in that it consists of four corner modules (2) equipped with two sockets (8) and short modules (4) and long modules (7) with two plugs (9) with a mounting recess (15) for two solidified screens (12) and (13), where the first screen (12) functions as a display and a touch panel and the second one (13) as a photovoltaic material.

3. The frame according to claim 1, characterised in that it consists of additional short modules (3) with two sockets (8) and/or short modules (5) with three plugs (9) and/or short modules (6) with two plugs (9) and a socket (8) and/or modules (10) with a plug pressed into the housing (9)

4. The frame according to claim 1, characterised in that it consists of additional long modules (11) with two plugs (9) and a socket (8) outside the frame (1) for connection to external and other devices

5. The frame according to claim 1, characterised in that the frame (1) solidified and configured as stated above consists of and comprises inside its and in a mounting recess (15) a typical phone (14) with an additional screen (13) serving as a photovoltaic material or having other unknown uses
